(19) United States
(12) Patent Application Publication
(10) Pub. No.: US 2004/0010769 A1
(43) Pub. Date: Jan. 15, 2004

(54) Method for reducing a pitch of a procedure

(75) Inventors: Ching-Yu Chang, I-Lan (TW); Wei-Ming Chung, Taipei (TW)

Correspondence Address: LOWE HAUPTMAN GILMAN & BERNER LLP, Suite 310, 1700 Diagonal Road, Alexandria, VA, 22314, US

(73) Assignee: Macronix International Co., Ltd.

(21) Appl. No.: 10/193,225

(22) Filed: Jul. 12, 2002

(51) Int. Cl. G06F 17/50

(52) U.S. Cl. 716/21; 700/121

(57) ABSTRACT

This invention relates to a method for reducing a width of a procedure, more particularly, to a method for reducing a pitch of the procedure. At first, the first photoresist layer is formed on the partial substrate and the first material layer is formed on sidewalls of the first photoresist layer. When the first photoresist layer is removed in order to conform needs of the procedure, the first phase procedure of the present invention is finished and the first material layer is formed on the partial substrate. When the second phase procedure of the present invention is proceed to conform the needs of the procedure, the second photoresist layer is formed on the partial substrate and on sidewalls of the first material layer after the first material layer is formed on the sidewalls of the first photoresist layer. Then the first photoresist layer is removed to form a trench and the second material layer is formed on the sidewalls of the trench. At last, the second photoresist layer is removed to form a complex layer, which comprises the first material layer and the second material layer, on the partial substrate and the second phase procedure of the present invention is finished. The first material layer is contact with the second material layer.

### BACKGROUND OF THE INVENTION

1. Field of the Invention

This invention relates to a method for reducing a width of a procedure, more particularly, to a method for reducing a pitch of the procedure to reduce a size of a critical dimension (CD), to reduce the pitch of the procedure, and to increase a proceeding flexibility of the procedure.

2. Description of the Prior Art

When a density of integrated circuits is increased continuously, the only method is to reduce a design rule of circuits continuously in order to keep a square measure of a chip or to reduce it. When the design rule is reduced, the most serious choke point is in technologies of a photolithography procedure. Unless the procedure's width of the photolithography procedure is reduced smaller and smaller, a development of the integrated circuit technologies will be limited.

The photolithography procedure of the integrated circuit technologies is to transform numerous electron parts and circuits on the chip, whose size is very small, by using a way in layer and layer. Each layer has a piece of a photo mask and lights pass through the photo mask and lenses to transform a picture from the photo mask to a surface of the chip by using an optical imaging theorem. The surface of the chip must have a sensitive material like a negative or a photoresist layer to react with the lights. Then the picture of the photo mask will be transformed to the chip completely after a chemical reaction. Therefore, the photo mask, the photoresist layer, a spreading and development apparatus, and an exposure calibrator are requisitions of the photolithography procedure. Following advancements of the integrated circuit technology, the amount of elements, which are fixed in a chip, is increased continuously. This condition will cause the width of lines being reduced continuously. Therefore, technologies like finding newer materials and break through the choke point of an optic will become challenges of the photolithography procedure.

Moreover, the photoresist layer, which is used in the photolithography procedure, is a sensitive mater for the lights. When the photoresist layer is exposed on the common lights, it will have a variation and will not reach its regular functions. The negative of a photo is treated in a darkroom. The photolithography procedure is also proceeded in a special environment. This special environment is usually called a photolithography chamber. Because the circuits of the integrated circuit are complex and the circuit width of the integrated circuit is smaller than a micron. Therefore, the integrated circuits must be produced in a desinfection chamber. Demands of a clean degree are more serious in the photolithography procedure. Any dust and particle will be transformed on the chip to cause defects of elements and to blur the circuits of the chips.

Following a volume of the integrated circuit element is reduced, volumes of semiconductor elements are reduced day after day. But the photolithography technology can not conform to needs of the procedure completely. This condition will make yields of the semiconductor elements and the proceeding efficiency of the whole procedure can not be increased. Referring to FIG. 1, this shows a diagram in forming a photoresist layer on the partial material layer. At first, a wafer, which comprises a substrate 10, is provided. Then a material layer 20 is formed on the substrate 10 and a photoresist layer 30 is formed on the material layer 20. Then the partial photoresist layer 30 is removed to form the photoresist layer 30 on the partial material layer 20 and following steps of a procedure are proceed according to needs of the procedure. When the procedure needs to implant ions into the partial material layer 20, the photoresist layer 30, which is remained on the partial material layer 20, is used to be a mask layer to prevent the ions entering into the partial material layer 20 which is under the photoresist layer 30. After passing through the implanting procedure and removing the photoresist layer 30, the material layer 20, which is on the substrate 20, is divided into two types. One type is an area 21 which comprises the implanted ions and the other type is an area 22 which does not comprise the implanted ions (referring to FIG. 2).

When the partial material layer 20 needs to be removed to form the material layer 20 on the partial substrate 10, the photoresist layer 30, which is formed on the partial material is used to be a mask layer to prevent the partial material layer 20 which is under the photoresist layer 30 to be removed in the removing procedure. After passing through a removing procedure to remove the partial material layer 20 and the photoresist layer 30, the material layer 20 is formed on the partial substrate 10 (referring to FIG. 3). The removing procedure comprises a etching procedure.

In the photolithography procedure to remove the partial photoresist layer 30 and to form the photoresist layer on the partial material layer 20, the light diffraction will affect pictures with each other to make the pictures, which is on the chip, are not true and to make the process window is reduced because of the defect in optical proximity effect (OPE). When the size of the semiconductor element is smaller and smaller, the defect in optical proximity effect will become more and more serious to affect the process window of the following procedure. When the ions will be implanted into the partial material layer 20, the picture, which is on the photo mask, can not be transformed to the photoresist layer 30 because the photoresist layer 30, which is formed on the partial material layer 20, is affected with the optical proximity effect. Therefore, the ions will not enter into the designed scope of the material layer 20 in the following ions implanting procedure to cause the defects in the semiconductor elements.

When the material layer 20 needs to be formed on the partial substrate, the picture, which is on the photo mask, can not be transformed to the photoresist layer 30 because the photoresist layer 30, which is formed on the partial material layer 20, is affected with the optical proximity effect. Therefore, the size of the material layer 20, which is formed on the partial substrate 10, can not be controlled to affect performances of the semiconductor elements.

A material, which is exposed by using a deep ultraviolet (DUV) light, and an off axis image (OAI) light, which is usually used to be a light source of an exposure apparatus, are used in the photolithography procedure, which is used to produce small size semiconductor elements, at present. This way is used to transform the picture from the photo mask to the wafer completely in the limitation of the smaller size. But this way always has its limitation and can not make the process window of the semiconductor element be reduced continuously. This way will also limit the proceeding efficiency and the proceeding flexibility of the procedure.

### SUMMARY OF THE INVENTION

In accordance with the above-mentioned invention backgrounds, the traditional method will complicate the procedure easily, reduce the proceeding efficiency of the procedure easily, reduce the proceeding flexibility easily, and increase the proceeding cost of the procedure. The main objective of the present invention is to reduce the critical dimension of the semiconductor element by using a single photo mask to form a photoresist layer on the partial substrate, forming a material layer on sidewalls of the photoresist layer, and removing the photoresist layer.

The second objective of this invention is to decrease the pitch of the procedure by using a single photo mask to form a photoresist layer on the partial substrate, forming a material layer on sidewalls of the photoresist layer, and removing the photoresist layer.

The third objective of this invention is to increase the proceeding efficiency of the procedure by using a single photo mask to form a photoresist layer on the partial substrate, forming a material layer on sidewalls of the photoresist layer, and removing the photoresist layer.

The fourth objective of this invention is to increase the proceeding flexibility of the procedure by using a single photo mask to form a photoresist layer on the partial substrate, forming a material layer on sidewalls of the photoresist layer, and removing the photoresist layer.

The fifth objective of this invention is to reduce the proceeding cost of the procedure by using a single photo mask to form a photoresist layer on the partial substrate, forming a material layer on sidewalls of the photoresist layer, and removing the photoresist layer.

It is a further objective of this invention to increase qualities of the semiconductor elements by using a single photo mask to form a photoresist layer on the partial substrate, forming a material layer on sidewalls of the photoresist layer, and removing the photoresist layer.

In according to the foregoing objectives, the present invention provides a method to reduce the process window. At first, the first photoresist layer is formed on the partial substrate and the first material layer is formed on sidewalls of the first photoresist layer. When the first photoresist layer is removed in order to conform needs of the procedure, the first phase procedure of the present invention is finished and the first material layer is formed on the partial substrate. When the second phase procedure of the present invention is proceed to conform the needs of the procedure, the second photoresist layer is formed on the partial substrate and on sidewalls of the first material layer after the first material layer is formed on the sidewalls of the first photoresist layer. Then the first photoresist layer is removed to form a trench and the second material layer is formed on the sidewalls of the trench. At last, the second photoresist layer is removed to form a complex layer, which comprises the first material layer and the second material layer, on the partial substrate and the second phase procedure of the present invention is finished. The first material layer is contact with the second material layer. The method of the present invention can reduce the critical dimension of the semiconductor element and decrease the pitch of the procedure. The method of the present invention can also increase the proceeding efficiency and the proceeding flexibility of the procedure. The method of the present invention can further reduce the proceeding cost of the procedure and increase qualities of the semiconductor elements.

### BRIEF DESCRIPTION OF THE DRAWINGS

In the accompanying drawing forming a material part of this description, there is shown:

FIG. 1 shows a diagram in forming a photoresist layer on a partial material layer;

FIG. 2 shows a diagram in implanting ions into the partial material layer;

FIG. 3 shows a diagram in forming the material layer on a partial substrate;

FIG. 4 shows a diagram in forming the first photoresist layer on the partial substrate;

FIG. 5 shows a diagram in forming the first material layer on sidewalls of the first photoresist layer;

FIG. 6 shows a diagram in forming the first material on the partial substrate;

FIG. 7 shows a diagram in forming the second photoresist layer on the partial substrate;

FIG. 8 shows a diagram in forming the first material layer, the second photoresist layer, and a trench on the substrate;

FIG. 9 shows a diagram in forming the second material layer on sidewalls of the trench; and

FIG. 10 shows a diagram in forming a complex layer, which comprises the first material layer and the second material, on the partial substrate.

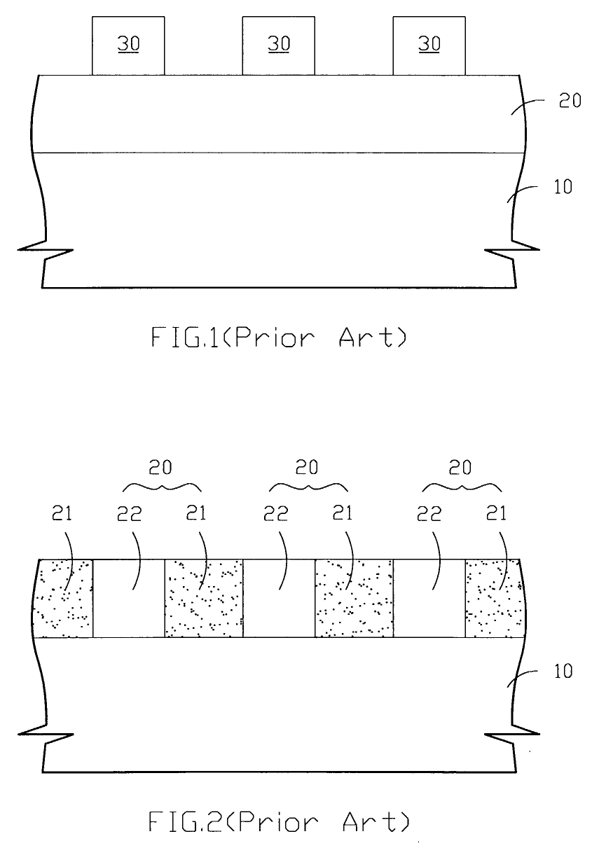

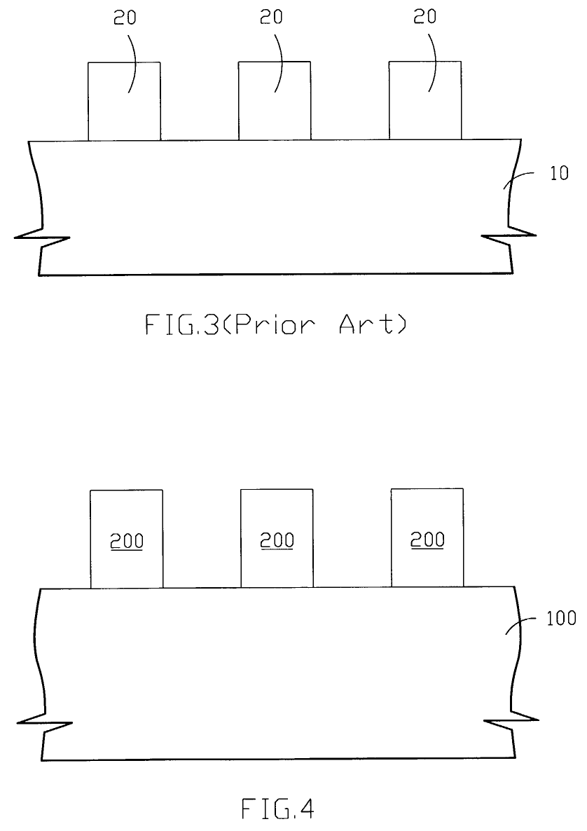

### DESCRIPTION OF THE PREFERRED EMBODIMENT

The foregoing aspects and many of the attendant advantages of this invention will become more readily appreciated as the same becomes better understood by reference to the following detailed description, when taken in conjunction with the accompanying drawings, wherein:

Referring to FIG. 4, this shows a diagram in forming the first photoresist layer on a partial substrate. At first, a wafer, which comprises a substrate 100, is provided. Then the first photoresist layer 200 is formed on the substrate 100. A material of the first photoresist layer 200 is the material, which is exposed by using a deep ultraviolet light, or the material, which is exposed by using an i-line light. Both these two kind materials will not limit the scope of the present invention. The material, which is exposed by using a deep ultraviolet light, is usually used to be the material of the first photoresist layer 200. Then the first photolithography procedure is proceeded to transform a picture from a photo mask to the first photoresist layer 200 by using the photo mask. Then the partial first photoresist layer 200 is removed to form the photoresist layer 200 on the partial substrate 100. In the photolithography procedure, a light source of a exposure apparatus is any kind of lights, such as: an off axis image light, a deep ultraviolet light, and i-line light. Following needs of the procedure, a positive photoresist layer or a negative photoresist layer can be used to be a material of the first photoresist layer 200. If the photoresist layer is the positive photoresist layer, the partial positive photoresist layer, which is exposed, will be removed in the following developing procedure by the developer and the partial positive photoresist layer, which is not exposed, will be remained. If the photoresist layer is the negative photoresist layer, the partial negative photoresist layer, which is not exposed, will be removed in the following developing procedure by the developer and the partial negative photoresist layer, which is exposed, will be remained.

Referring to FIG. 5, this shows a diagram in forming the first material layer on sidewalls of the first photoresist layer. At first, the first material layer 300 is formed on the substrate 100 and the first photoresist layer 200. After passing through an etching back procedure to remove the partial first material layer 300 by using the etching selectivity, the first material layer 300 is formed on the sidewalls of the first photoresist layer 200. Most etching back procedures use the unisotropic etching procedure. A material of the first material layer 300 is a conformal polymer coating, a conformal oxide layer, a silylation layer, a reflex material, or a metal layer. Following different procedures, the different material is used to be the material of the first material layer 300. When several materials, such as: reflex material, are used to be the material of the first material layer 300, the first material layer 300 will be formed on the sidewalls of the first photoresist layer 200 directly and need not to be formed by using the etching back procedure. Therefore, the etching back procedure will be removed or remained on the method of the present invention following what kind material of the first material layer 300 it is.

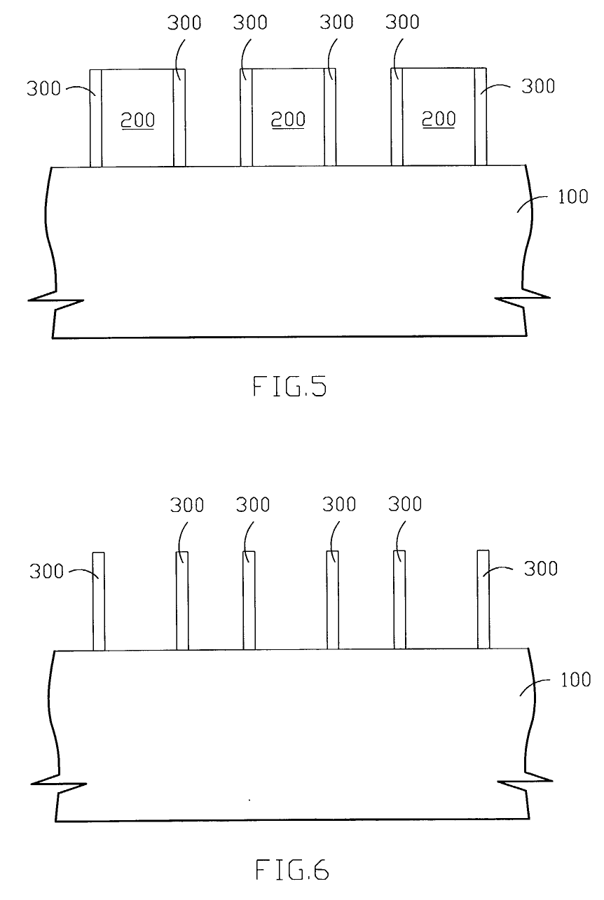

Referring to FIG. 6, this shows a diagram in forming the first material on the partial substrate. Following different needs of the procedure, the first photoresist layer 200 is removed and the first phase procedure of the present invention is finished after the first material layer 300 is formed on the sidewalls of the first photoresist layer 200. When a single layer of a material layer, whose width is very narrow, such as: the metal layer or a poly-silicon layer, is formed on the substrate, the first phase procedure of the present invention must be used to form the material layer, whose width is very thin, on the substrate successfully. The first phase procedure of the present invention will not be limited by the photolithography procedure and etching procedure and will form the material layer, whose width is not limited, on the substrate. Using the first phase procedure of the present invention can also form the narrower width and smaller pitch of the material layer in faster proceeding efficiency. Using the first phase procedure of the present invention can further form the narrower width and different pitches of the material layer on the substrate.

Referring to FIG. 7, this shows a diagram in forming the second photoresist layer on the partial substrate. When a complex layer is needed to form on the substrate 100, the second phase procedure of the present invention must be used to increase the proceeding efficiency of the procedure. After forming the first material layer 300 on the sidewalls of the first photoresist layer 200, the second photoresist layer 400 is formed on the sidewalls of the first material layer 300 by using the second photolithography procedure. The second photoresist layer 400 is located on the partial substrate 100 and is filled of the space, which is between two first material layers 300. A material, which is exposed by using an i-line light, is usually used to be the material of the second photoresist layer. This kind of material will not limit the scope of the present invention. A photo mask, which is used in the first photolithography procedure, is as the same as a photo mask, which is used in the second photolithography procedure to increase the proceeding efficiency of the procedure, to decrease the time of fixing the location of the photo masks, and to decrease the proceeding cost of the procedure. The material of the first photoresist layer 200 is different from the material of the second photoresist layer 400. Therefore, the exposure energy of the first photoresist layer is different from the exposure energy of the second photoresist layer.

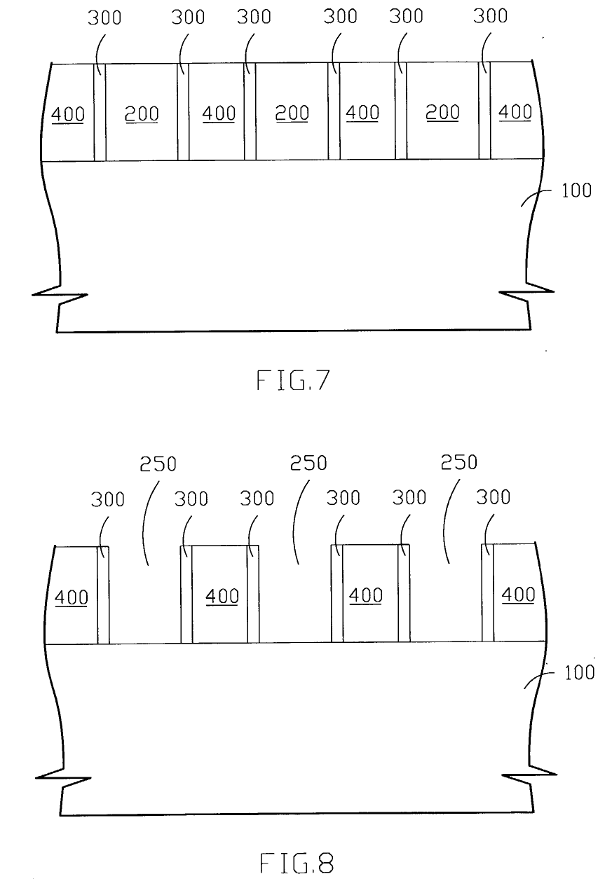

Referring to FIG. 8, this shows a diagram in forming the first material layer, the second photoresist layer, and a trench on the substrate. After forming the second photoresist layer on the partial substrate 100 and filling of the space, which is between two first material layers 300, the first photoresist layer 300 is removed to form the first material layer 300, the second photoresist layer 400, and a trench 250 on the substrate 100. The trench 250 is a space which is exist on the substrate 100 after removing the first photoresist layer 200. Because the exposure energy of the first photoresist layer is different from the exposure energy of the second photoresist layer. Therefore, when the first photoresist layer 200 is removed, the second photoresist layer 400 will not be removed at the same time.

Referring to FIG. 9, this shows a diagram in forming the second material layer on sidewalls of the trench. After removing the first photoresist layer 200, the second material layer 500 is formed on sidewalls of the trench 250. A material of the second material layer 500 is an oxide layer or a polymer layer. When the oxide layer is used to be the material of the second material layer 500, the second material layer 500 is formed on the substrate 100, the first material layer 300, the second phtoresist layer 400. After passing through an etching back procedure to remove the partial second material layer 500 by using the different etching selectivity, the second material layer 500 is formed on the sidewalls of the trench 250. The unisotropic etching procedure is most used in the etching back procedure. The first material layer 300 is contact with the second material layer 500.

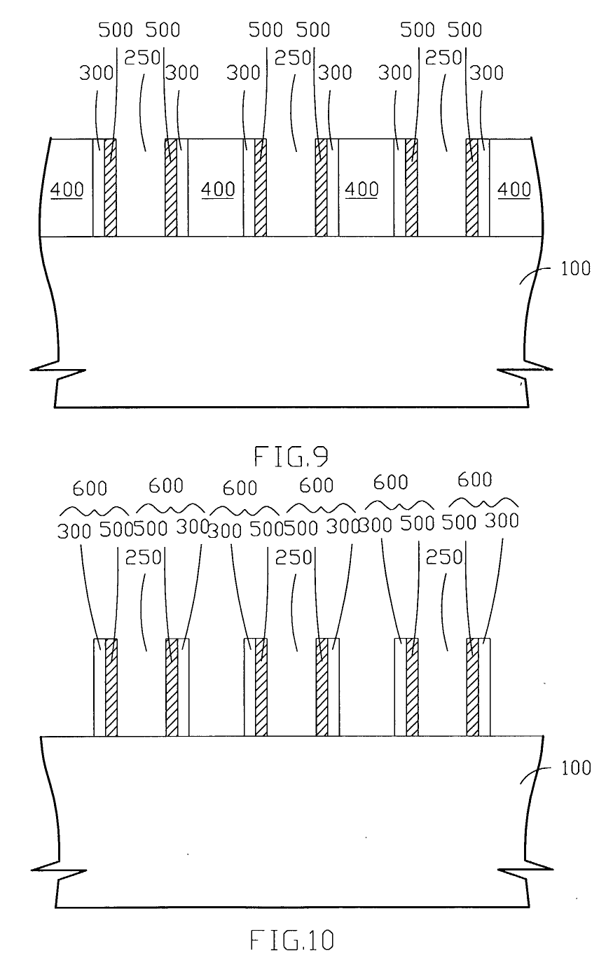

Referring to FIG. 10, this shows a diagram in forming a complex layer, which comprises the first material layer and the second material, on the partial substrate. After forming the second material layer 500 on the sidewalls of the trench, the second photoresist layer 400 will be removed to form the complex layer, which comprises the first material layer 300 and the second material 500, on the partial substrate 100, wherein the first material layer 300 is contact with the second material layer 500. Following the different needs of the procedure, a material of the first material layer and a material of the second material layer can be the same or not. The complex layer, which comprises the first material layer 300 and the second material 500, can be used to be the mask layer in the following etching procedure or the ions implanting procedure or used to be the contacting layer to contact with other layers. Therefore, functions of the complex layer are very popular. Following different needs of the procedure, a width of the first material and a width of the second material can be the same or not.

The second phase procedure of the present invention will not be limited by the photolithography procedure and etching procedure and will form the complex layer, whose width is not limited, on the substrate. Using the second phase procedure of the present invention can also form the narrower width and smaller pitch of the complex layer in faster proceeding efficiency. Using the first phase procedure of the present invention can further form the narrower width and different pitches of the complex layer on the substrate to increase the proceeding flexibility of the procedure and to reduce the critical dimension of the semiconductor element.

In accordance with the present invention, the present invention provides a method to reduce the process window. At first, the first photoresist layer is formed on the partial substrate and the first material layer is formed on sidewalls of the first photoresist layer. When the first photoresist layer is removed in order to conform needs of the procedure, the first phase procedure of the present invention is finished and the first material layer is formed on the partial substrate. When the second phase procedure of the present invention is proceed to conform the needs of the procedure, the second photoresist layer is formed on the partial substrate and on sidewalls of the first material layer after the first material layer is formed on the sidewalls of the first photoresist layer. Then the first photoresist layer is removed to form a trench and the second material layer is formed on the sidewalls of the trench. At last, the second photoresist layer is removed to form a complex layer, which comprises the first material layer and the second material layer, on the partial substrate and the second phase procedure of the present invention is finished. The first material layer is contact with the second material layer. The method of the present invention can reduce the critical dimension of the semiconductor element and decrease the pitch of the procedure. The method of the present invention can also increase the proceeding efficiency and the proceeding flexibility of the procedure. The method of the present invention can further reduce the proceeding cost of the procedure and increase qualities of the semiconductor elements.

Although specific embodiments have been illustrated and described, it will be obvious to those skilled in the art that various modifications may be made without departing from what is intended to be limited solely by the appended claims.

What is claimed is:

1. a method for reducing a pitch of a procedure, said method comprises:
providing a wafer, wherein said wafer comprises a substrate;
forming a photoresist layer on said partial substrate;
forming a material layer on a sidewall of said photoresist layer; and
removing said photoresist layer.

2. The method according to claim 1, wherein a material of said photoresist layer is the material, which is exposed by using a deep ultraviolet light.

3. The method according to claim 1, wherein a material of said photoresist layer is the material, which is exposed by using an i-line light.

4. The method according to claim 1, wherein a material of said material layer is a conformal polymer coating.

5. The method according to claim 1, wherein a material of said material layer is a conformal oxide layer.

6. The method according to claim 1, wherein a material of said material layer is a silylation layer.

7. The method according to claim 1, wherein a material of said material layer is a reflex material.

8. The method according to claim 1, wherein a material of said material layer is a metal layer.

9. a method for reducing a pitch of a procedure, said method comprises:
providing a wafer, wherein said wafer comprises a substrate;
forming a first photoresist layer on said partial substrate;
forming a first material layer on a sidewall of said first photoresist layer;
forming a second photoresist layer on said partial substrate, wherein said second photoresist layer is located on a sidewall of said first material layer;
removing said first photoresist layer to form a trench on said substrate;
forming a second material layer on a sidewall of said trench, wherein said second material layer is contact with said first material layer; and
removing said second photoresist layer.

10. The method according to claim 9, wherein a material of said first photoresist layer is the material, which is exposed by using a deep ultraviolet light.

11. The method according to claim 9, wherein a material of said second photoresist layer is the material, which is exposed by using an i-line light.

12. The method according to claim 9, wherein a material of said first material layer is a conformal polymer coating.

13. The method according to claim 9, wherein a material of said first material layer is a conformal oxide layer.

14. The method according to claim 9, wherein a material of said first material layer is a silylation layer.

15. The method according to claim 9, wherein a material of said first material layer is a reflex material.

16. The method according to claim 9, wherein a material of said second material layer is an oxide.

17. The method according to claim 9, wherein a material of said second material layer is a polumer.

18. a method for reducing a pitch of a procedure, said method comprises:
providing a wafer, wherein said wafer comprises a substrate;
forming a first photoresist layer on said substrate;
transforming a picture from a photo mask to said first photoresist layer by using a light to form said first photoresist layer on said partial substrate;
forming a first material layer on said first photoresist layer and said partial substrate;
removing said partial first material layer to form said first material layer on a sidewall of said first photoresist layer;
forming a second photoresist layer on said partial substrate by using said mask and said light, wherein said second photoresist layer is located on a sidewall of said first material layer;
removing said first photoresist layer to form a trench on said substrate;
forming a second material layer on said partial substrate, said partial first material layer, and said partial second photoresist layer;
removing said partial second material layer to form said second material layer on a sidewall of said trench, wherein said first material layer is contact with said second material layer to become a complex layer; and
removing said second photoresist layer.

19. The method according to claim 18, wherein a material of said first photoresist layer is the material, which is exposed by using a deep ultraviolet light.

20. The method according to claim 18, wherein a material of said second photoresist layer is the material, which is exposed by using an i-line light.

21. The method according to claim 18, wherein a material of said first material layer is a conformal polymer coating.

22. The method according to claim 18, wherein a material of said first material layer is a conformal oxide layer.

23. The method according to claim 18, wherein a material of said second material layer is an oxide.

24. The method according to claim 18, wherein said light is an off axis image light.
